(19) United States
(12) Patent Application Publication
(10) Pub. No.: US 2016/0224817 A1
(43) Pub. Date: Aug. 4, 2016

(54) ELECTRONIC DEVICE HAVING FINGERPRINT RECOGNITION FUNCTION

(71) Applicants: GENERAL INTERFACE SOLUTION LIMITED, Miaoli County (TW); INTERFACE OPTOELECTRONIC (SHENZHEN) CO., LTD., SHENZHEN (CN)

(72) Inventor: MIN-LUN YANG, Hsinchu (TW)

(21) Appl. No.: 14/948,594

(22) Filed: Nov. 23, 2015

(30) Foreign Application Priority Data
Jan. 30, 2015 (CN) 201510048653.1

(51) Int. Cl. G06K 9/00; G06F 1/32; G06F 21/32; G06F 1/16

(52) U.S. Cl. CPC G06K 9/0002; G06F 1/16; G06K 9/00087; G06F 1/3265; G06F 21/32

(57) ABSTRACT

An electronic device includes at least one curved region, and at least one fingerprint sensor. The at least one fingerprint sensor is installed under the curved region to acquire fingerprint when the at least one curved region is touched.

### CROSS-REFERENCE TO RELATED APPLICATIONS

This application claims priority to Chinese Patent Application No. 201510048653.1 filed on Jan. 30, 2015, the contents of which are incorporated by reference herein.

### FIELD

The subject matter herein generally relates to a method for patterning conductive materials by using light annealing technologies.

### BACKGROUND

Fingerprint recognition technologies are utilized in various electronic devices, such as smart phones, tablet computers, personal digital assistants (PDA), and media players. For example, a smart phone may utilize at least one fingerprint sensor under a home screen key to sensing fingerprint. In addition, curved devices, such as smart watch, smart phone having curved outer housings, or other similar devices, have been developed. Curved devices may comprise outer housings permanently curved around one or more axes and may provide users with unique interfaces and user experiences.

### BRIEF DESCRIPTION OF THE DRAWINGS

Implementations of the present technology will now be described, by way of example only, with reference to the attached figures.

FIG. 1 illustrates a diagrammatic view of an electronic device according to a first embodiment.

FIG. 2 illustrates a cross sectional view of the electronic device taken long line II-II of FIG. 1.

FIG. 3 illustrates a cross sectional view of the electronic device taken long line III-III of FIG. 1.

FIG. 4 illustrates a diagrammatic view of functional modules of the electronic device of FIG. 1.

FIG. 5 illustrates a diagrammatic view of an electronic device according to a second embodiment.

FIG. 6 illustrates a cross sectional view of the electronic device taken long line V-V of FIG. 5.

FIG.7 illustrates a cross sectional view of the electronic device taken long line VI-VI of FIG. 5.

FIG. 8 illustrates a diagrammatic view of functional modules of the electronic device of FIG. 5.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The term “coupled” is defined as connected, whether directly or indirectly through intervening components, and is not necessarily limited to physical connections. The connection can be such that the objects are permanently connected or releasably connected. The term “comprising”, when utilized, means “including, but not necessarily limited to”; it specifically indicates open-ended inclusion or membership in the so-described combination, group, series and the like. The term “a plurality of”, when utilized, means “at least two”.

The present disclosure is described in relation to a method for forming electrode patterns on a substrate using light annealing technologies. In summary, a layer of conductive materials is formed on the substrate, and a portion of the conductive materials is annealed by an exposing manner. The layer of conductive materials after being extended includes an annealed first portion and an unannealed second portion. One of the annealed first portion and the unannealed second portion is removed from the substrate to form electrode patterns on the substrate. More details are provided below.

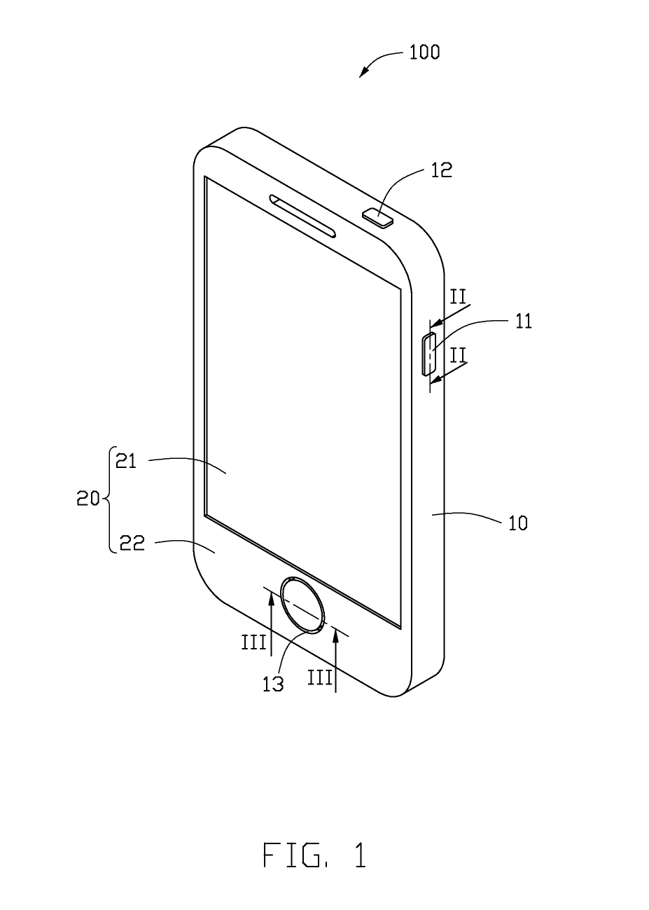

FIG. 1 illustrates a diagrammatic view of an electronic device 100 according to a first embodiment. The electronic device 100 can include a housing 10 and a cover 20 coupled with the housing 10 to define a receiving space to receive components of the electronic device 100. In at least one embodiment, the cover 20 includes a transparent region 21 and a non-transparent region 22. The transparent region 21 corresponds to a display area of the electronic device 100. The cover 20 can be made of glasses. Therefore, the cover 20 can also be called “cover glass” or “protection glass”.

The electronic device 100 further includes a plurality of buttons. In at least one embodiment, the electronic device 100 at least includes a first button 11, a second button 12, and a third button 13. The first button 11 and the second button 12 pass through and extend out of the housing 10. The third button 13 passes through and extends out of the cover 20. The first button 11 can be a power button of the electronic device 100. The second button 12 can be a volume adjustment button for the electronic device 100. The third button 13 can be a home screen button of the electronic device 100. In at least one example, the cover 20 can define a through hole in the non-transparent region. Thus, the third button 13 can pass through the through hole, thereby extending out from the cover 20.

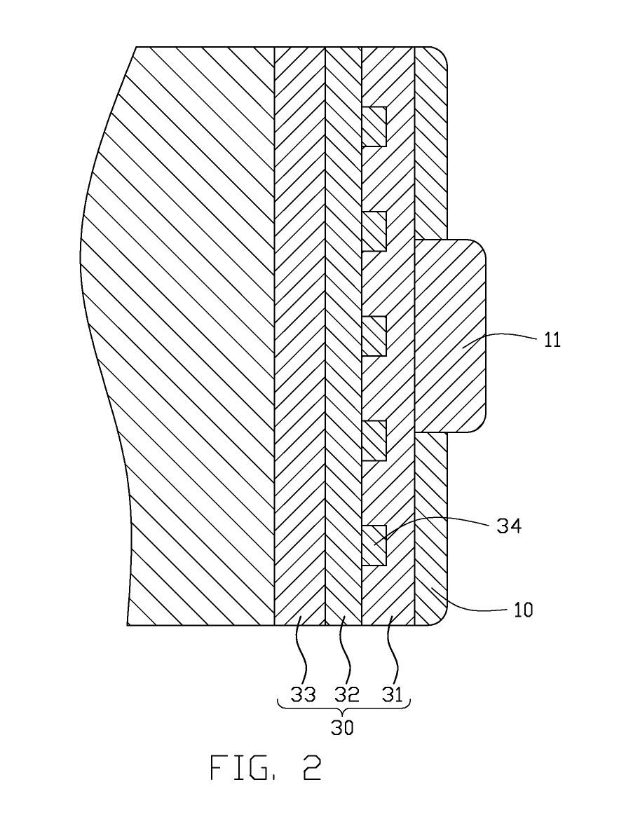

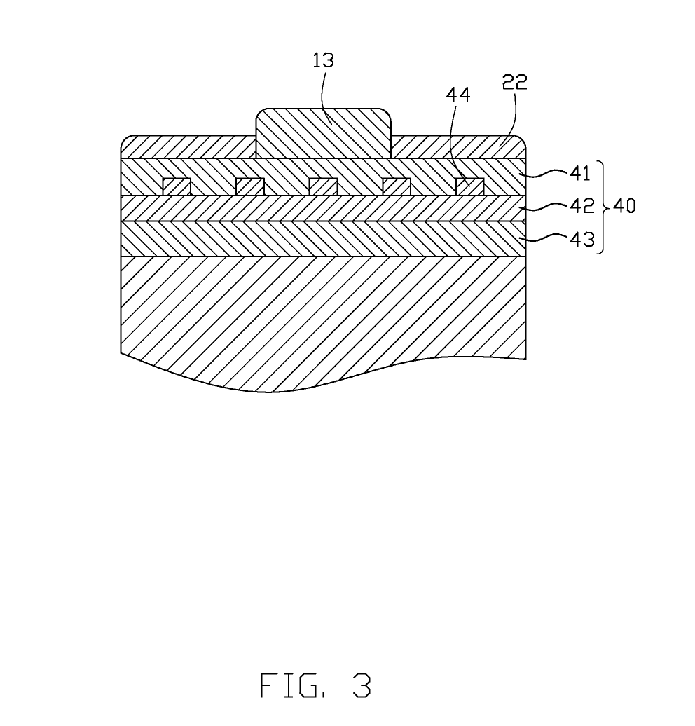

The electronic device 100 further includes at least two fingerprint sensors respectively located under at least two of the plurality of buttons. For example, referring to FIG. 2, the electronic device 100 can include a first fingerprint sensor 30 located under the first button 11. Referring FIG. 3, the electronic device can further include a second fingerprint sensor 40 located under the third button 13. Each of the first and second fingerprint sensors 30 and 40 can be an optical fingerprint sensor, a heat induction fingerprint sensor, an ultrasonic fingerprint sensor, or a capacitance fingerprint sensor. Both the first fingerprint sensor 30 and the second fingerprint sensor 40 are ultrasonic fingerprint sensors. The at least two fingerprint sensors are configured to acquire fingerprint information from user when any of the buttons is touched by at least one finger of the user.

Further referring FIG. 2, the first fingerprint sensor 30 can include a substrate 32 and a pair of electrode layers comprising a first electrode layer 31 and a second electrode layer 33 respectively coupled at opposite surfaces of the substrate 32. The substrate 32 can be a thin film transistor (TFT) substrate having a plurality of TFTs 34. In other embodiments, the substrate 32 can also be a glass substrate, such as a chemically strengthened glass substrate.

The first electrode layer 31 can include a layer of piezoelectric materials and two layers of conductive materials respectively coated on opposite surfaces of the layer of piezoelectric materials. For example, the conductive materials can be metal materials having good conductive performance Some example of the metal materials include, but not limit to, argentums, aluminum, copper, nickel, or alloy thereof. In other embodiments, the conductive materials can be transparent conductive materials, such as indium tin oxide, zinc oxide, Ag nano wire, or graphene. The piezoelectric materials can be polyvinylidene fluoride.

The conductive materials can be formed on the opposite surfaces of the layer of piezoelectric materials by a vacuum sputtering method, an electroplate method, or a coating method, to form the first electrode layer 31. A thickness of the conductive materials formed on the opposite surfaces of the layer of piezoelectric materials is about from 400 angstroms to 1000 angstroms.

In at least one embodiment, the first electrode layer 31 can be attached on the surface of the substrate 32 by adhesive materials, such as liquid adhesive, double side adhesive, or optical adhesive (such as optical clear adhesive or optical clear resin).

The second electrode layer 33 is similar to the first electrode layer 31. The second electrode layer 33 can include a layer of piezoelectric materials and two layers of conductive materials respectively coated on opposite surfaces of the layer of piezoelectric materials. For example, the conductive materials can be metal materials having good conductive performance Some example of the metal materials include, but not limit to, argentums, aluminum, copper, nickel, or alloy thereof. In other embodiments, the conductive materials can be transparent conductive materials, such as indium tin oxide, zinc oxide, Poly(3,4-ethylenedioxythiophene), carbon nanotube, Ag nano wire, or graphene. The piezoelectric materials can be polyvinylidene fluoride.

The conductive materials can be formed on the opposite surfaces of the layer of piezoelectric materials by a vacuum sputtering method, an electroplate method, or a coating method, to form the second electrode layer 33. A thickness of the conductive materials formed on the opposite surfaces of the layer of piezoelectric materials is about from 400 angstroms to 1000 angstroms.

In at least one embodiment, the second electrode layer 33 can serve as a signal transmission layer to produce ultrasonic waves when it is powered. When an external object touches or moves to the first fingerprint sensor 30, the ultrasonic waves come to the external object and are reflected by the external object. The first electrode layer 31 can serve as a signal receiving layer to receive the ultrasonic waves reflected from the external object and to convert the ultrasonic waves into electric signals. The electric signals are transmitted to the TFTs 34 for analyzing, thereby realizing the fingerprint recognition function of the first fingerprint sensor 30.

Further referring FIG. 3, the second fingerprint sensor 40 is similar to the first fingerprint sensor 30. The second fingerprint sensor 40 includes a substrate 42 and a pair of electrode layers comprising a first electrode layer 41 and a second electrode layer 43 respectively coupled at opposite surfaces of the substrate 42. The substrate 42 can be a thin film transistor (TFT) substrate having a plurality of TFTs 44. In other embodiments, the substrate 42 can also be a glass substrate, such as a chemically strengthened glass substrate.

The first electrode layer 41 can include a layer of piezoelectric materials and two layer of conductive materials respectively coated on opposite surfaces of the layer of piezoelectric materials. For example, the conductive materials can be metal materials having good conductive performance Some example of the metal materials include, but not limit to, argentums, aluminum, copper, nickel, or alloy thereof. In other embodiments, the conductive materials can be transparent conductive materials, such as indium tin oxide, zinc oxide, Poly(3,4-ethylenedioxythiophene), carbon nanotube, Ag nano wire, or graphene. The piezoelectric materials can be polyvinylidene fluoride.

The conductive materials can be formed on the opposite surfaces of the layer of piezoelectric materials by a vacuum sputtering method, an electroplate method, or a coating method, to form the first electrode layer 41. A thickness of the conductive materials formed on the opposite surfaces of the layer of piezoelectric materials is about from 400 angstroms to 1000 angstroms.

In at least one embodiment, the first electrode layer 41 can be attached on the surface of the substrate 42 by adhesive materials, such as liquid adhesive, double side adhesive, or optical adhesive (such as optical clear adhesive or optical clear resin).

The second electrode layer 43 is similar to the first electrode layer 41 and it can include a layer of piezoelectric materials and two layer of conductive materials respectively coated on opposite surfaces of the layer of piezoelectric materials. For example, the conductive materials can be metal materials having good conductive performance. Some example of the metal materials include, but not limit to, argentums, aluminum, copper, nickel, or alloy thereof. In other embodiments, the conductive materials can be transparent conductive materials, such as indium tin oxide, zinc oxide, Poly(3,4-ethylenedioxythiophene), carbon nanotube, Ag nano wire, or graphene. The piezoelectric materials can be polyvinylidene fluoride.

The conductive materials can be formed on the opposite surfaces of the layer of piezoelectric materials by a vacuum sputtering method, an electroplate method, or a coating method, to form the second electrode layer 43. A thickness of the conductive materials formed on the opposite surfaces of the layer of piezoelectric materials is about from 400 angstroms to 1000 angstroms.

In at least one embodiment, the second electrode layer 43 can serve as a signal transmission layer to produce ultrasonic waves when it is powered. When an external object touches or moves to the second fingerprint sensor 40, the ultrasonic waves come to the external object and are reflected by the external object. The first electrode layer 41 can serve as a signal receiving layer to receive the ultrasonic waves reflected from the external object and to convert the ultrasonic waves into electric signals. The electric signals are transmitted to the TFTs 44 for analyzing, thereby realizing the fingerprint recognition function of the second fingerprint sensor 40.

In other embodiments, the electronic device 100 can further include a third fingerprint sensor (not shown) located under the third button 13. The third fingerprint sensor can have the same or similar structure with the first and second fingerprint sensors 30, 40, details thereof are omitted.

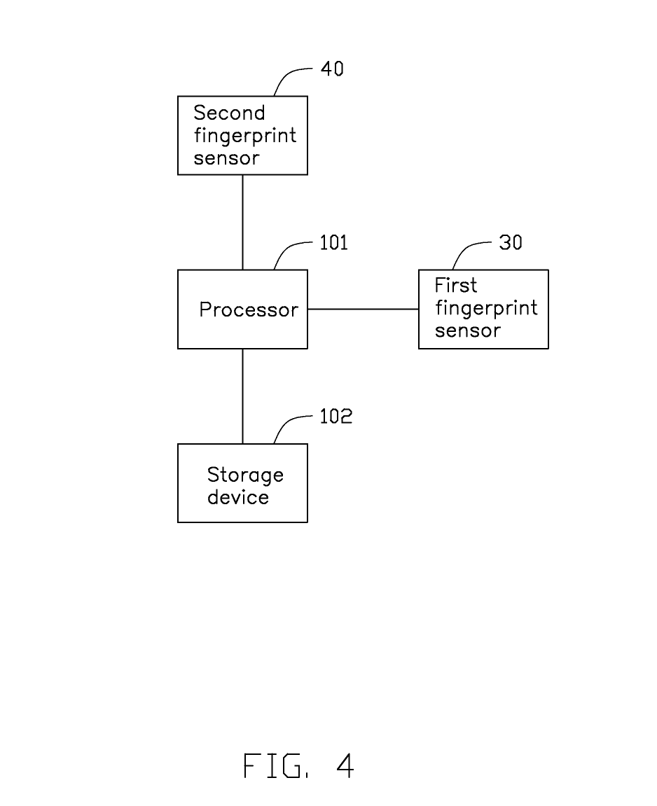

As illustrated in FIG. 4, the electronic device 100 can further includes a processor 101 and a storage device 102 coupled to the processor 101. The processor 101 is coupled to both the first fingerprint sensor 30 and the second fingerprint sensor 40. In at least one embodiment, each of the first and second fingerprint sensors 30, 40 is associated with a predetermined function of the electronic device 100. When one of the first and second fingerprint sensors 30, 40 acquires a fingerprint which matches one of at least one predetermined fingerprint stored in the storage device 102, the processor 101 controls the electronic device 100 to perform the predetermined function associated with the one of the first and second fingerprint sensors 30, 40.

In at least one embodiment, the first fingerprint sensor 30 can be associated with a first function of the electronic device 100 and the second fingerprint sensor 40 is associated with a second function of the electronic device 100. The first function may be to power off the electronic device 100 and the second function may be to unlock the electronic device 100. A first predetermined fingerprint and a second predetermined fingerprint may be pre-stored in the storage device 102. When a fingerprint is acquired by the first fingerprint sensor 30, the processor 101 compares the acquired fingerprint with the first predetermined fingerprint. If the acquired fingerprint matches the first predetermined fingerprint, the processor 101 automatically powers off the electronic device 100. In the same manner, if the second fingerprint sensor 40 acquires a fingerprint that matches the second predetermined fingerprint, the processor 101 may unlock the electronic device 100. Thus, some functions of the electronic device 100 can be quickly and automatically triggered when appropriated fingerprints are input.

As described above, besides the fingerprint sensor (second fingerprint sensor 40) installed under the home screen button (third button 13) of the electronic device 100, the electronic device 100 further includes the other fingerprint sensor (first fingerprint sensor 30) installed under the power button (first button 11). Thus, when the home screen button malfunctions due to a large number of pressing operations applied thereon, the user can also input fingerprints using the other fingerprint sensor located under the power button to operate the electronic device 100.

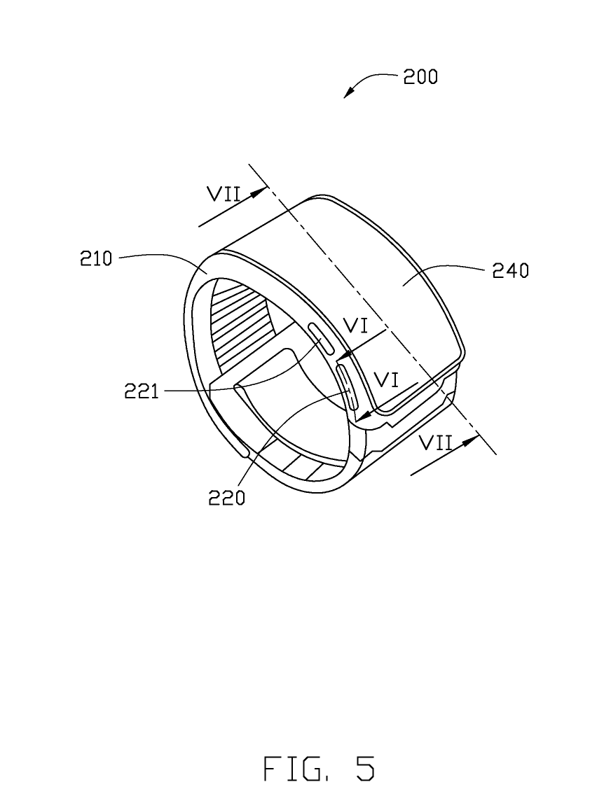

FIG. 5 illustrates a diagrammatic view of an electronic device 200 according to a second embodiment. In at least one embodiment, the electronic device 200 can be a curved device such as a curved smart phone, a smart car key, a smart watch, or other devices the like. In this embodiment, the curved device 200 is a smart watch for an example.

The electronic device 200 includes at least one curved region 210 and at least one button including at least a first button 220 and a second button 221 located within the curved region 210. In at least one embodiment, the electronic device 200 further includes at least one fingerprint sensor installed under the curved region 210. For example, a first fingerprint sensor 230 is located under the first button 220. The first fingerprint sensor 230 can be an optical fingerprint sensor, a heat induction fingerprint sensor, an ultrasonic fingerprint sensor, or a capacitance fingerprint sensor. The first fingerprint sensor 230 is an ultrasonic fingerprint sensor. The first fingerprint sensor 230 is configured to acquire fingerprints from user when the first button 220 buttons is touched by at least one finger of the user, thereby controlling the electronic device 200 to execute corresponding functions according to the fingerprints acquired by the first fingerprint sensor 230.

In at least one embodiment, the first button 230 and the second button 221 can be mechanical buttons protruding from the at least one curved region. In other embodiment, the first button 230 and the second button 221 can be virtual buttons defined by software programs. Thus, the first button 230 and the second button 221 can be marked by various identifiers (such as patterns, texts, or numbers) within the at least one curved region. In at least one embodiment, the curved region 210 refers to a part of the electronic device 200 having a curved shape (such as have a curved inner side surface and a curved outside surface).

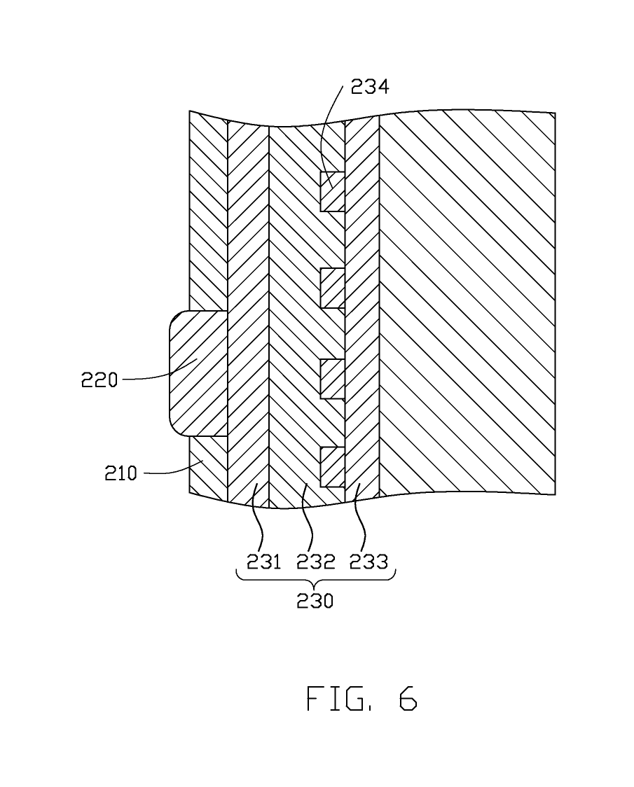

As illustrated in FIG. 6, the first fingerprint sensor 230 includes a substrate 232 and a pair of electrode layers comprising a first electrode layer 231 and a second electrode layer 232 coupled at opposite sides of the substrate 230. The substrate 232 can be a thin film transistor (TFT) substrate having a plurality of TFTs 234. In other embodiments, the substrate 232 can also be a glass substrate, such as a chemically strengthened glass substrate. In this embodiment, in order to fit the curved region, the substrate 232 of the first fingerprint sensor 30 can be a flexible thin film substrate made of flexible materials, such as plastics or polymer transparent resin materials. The first electrode layer 231, the substrate 232, and the second electrode layer 233 each has the same shape with the curved region 210.

The first electrode layer 231 can include a layer of piezoelectric materials and two layer of conductive materials respectively coated on opposite surfaces of the layer of piezoelectric materials. For example, the conductive materials can be metal materials having good conductive performance Some example of the metal materials include, but not limit to, argentums, aluminum, copper, nickel, or alloy thereof. In other embodiments, the conductive materials can be transparent conductive materials, such as indium tin oxide, zinc oxide, Poly(3,4-ethylenedioxythiophene), carbon nanotube, Ag nano wire, or graphene. The piezoelectric materials can be polyvinylidene fluoride.

The conductive materials can be coated on the opposite surfaces of the layer of piezoelectric materials by a vacuum sputtering method, an electroplate method, or a coating method, to form the first electrode layer 231. A thickness of the conductive materials formed on the opposite surfaces of the layer of piezoelectric materials is about from 400 angstroms to 1000 angstroms.

In at least one embodiment, the first electrode layer 231 can be attached on the surface of the substrate 232 by adhesive materials, such as liquid adhesive, double side adhesive, or optical adhesive (such as optical clear adhesive or optical clear resin).

The second electrode layer 233 is similar to the first electrode layer 231. The second electrode layer 233 can include a layer of piezoelectric materials and two layers of conductive materials respectively coated on opposite surfaces of the layer of piezoelectric materials. For example, the conductive materials can be metal materials having good conductive performance Some example of the metal materials include, but not limit to, argentums, aluminum, copper, nickel, or alloy thereof. In other embodiments, the conductive materials can be transparent conductive materials, such as indium tin oxide, zinc oxide, Poly(3,4-ethylenedioxythiophene), carbon nanotube, Ag nano wire, or graphene. The piezoelectric materials can be polyvinylidene fluoride.

In at least one embodiment, the second electrode layer 233 can serve as a signal transmission layer to produce ultrasonic waves when it is powered. When an external object touches or moves to the first fingerprint sensor 230, the ultrasonic waves come to the external object and are reflected by the external object. The first electrode layer 231 can serve as a signal receiving layer to receive the ultrasonic waves reflected from the external object and to convert the ultrasonic waves into electric signals. The electric signals are transmitted to the TFTs 234 for analyzing, thereby realizing the fingerprint recognition function of the first fingerprint sensor 230.

In other embodiments, the other fingerprint (not shown) can also be installed under the second button 221. The other fingerprint sensor can have the same or similar structure with the first fingerprint sensors 230, details thereof are omitted.

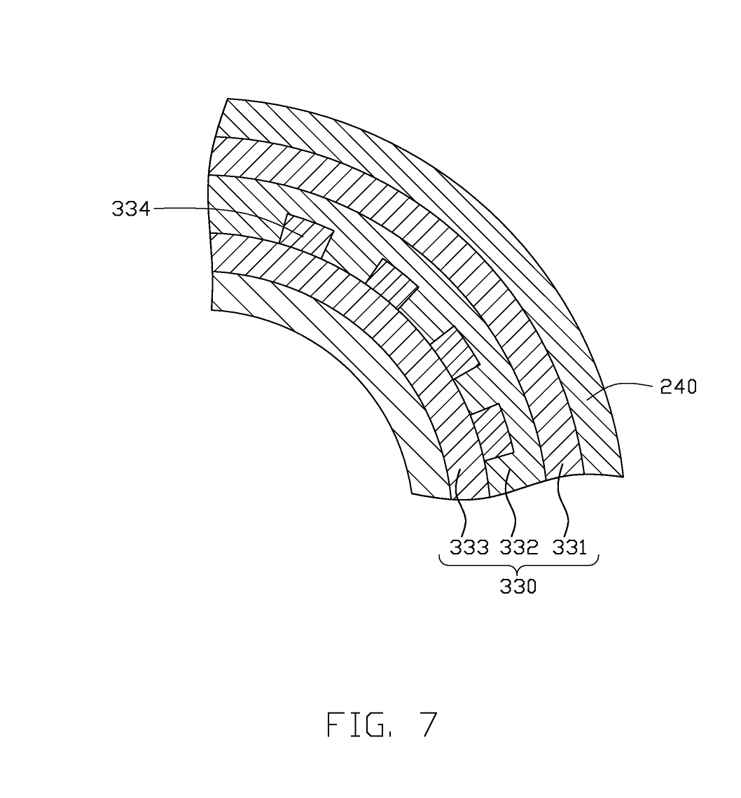

Further referring to FIG. 5, the electronic device 200 further includes a display 240. The display 240 can be a curved display screen. Referring to FIG. 7, the electronic device 200 further includes a second fingerprint sensor 330 located under the display 240. The second fingerprint sensor 330 is configured to acquire fingerprint from user when the display 240 is touched by any finger of the user. The second fingerprint sensor 330 can be an optical fingerprint sensor, a heat induction fingerprint sensor, an ultrasonic fingerprint sensor, or a capacitance fingerprint sensor. The second fingerprint sensor 330 is an ultrasonic fingerprint sensor. In order to fit the shape of the display 240, the second fingerprint sensor 330 is curve shaped as well as the display 240. The second fingerprint sensor 330 can be located corresponding to a virtual button displayed on the display 240 to acquire the fingerprint at the time when the virtual button is touched.

The second fingerprint sensor 330 includes a substrate 332 and a pair of electrode layers comprising a first electrode layer 331 and a second electrode layer 332 coupled at opposite sides of the substrate 330. The substrate 332 can be a thin film transistor (TFT) substrate having a plurality of TFTs 334. In other embodiments, the substrate 332 can also be a glass substrate, such as a chemically strengthened glass substrate. In this embodiment, in order to fit the curved region, the substrate 332 of the second fingerprint sensor 330 can be a flexible thin film substrate made of flexible materials, such as plastics or polymer transparent resin materials. The first electrode layer 331, the substrate 332, and the second electrode layer 333 each has the same shape with the curved display 240, such as each has a curved inner side surface and a curved outside surface.

The first electrode layer 331 can include a layer of piezoelectric materials and two layer of conductive materials respectively coated on opposite surfaces of the layer of piezoelectric materials. For example, the conductive materials can be metal materials having good conductive performance Some example of the metal materials include, but not limit to, argentums, aluminum, copper, nickel, or alloy thereof. In other embodiments, the conductive materials can be transparent conductive materials, such as indium tin oxide, zinc oxide, Poly(3,4-ethylenedioxythiophene), carbon nanotube, Ag nano wire, or graphene. The piezoelectric materials can be polyvinylidene fluoride.

The conductive materials can be coated on the opposite surfaces of the layer of piezoelectric materials by a vacuum sputtering method, an electroplate method, or a coating method, to form the first electrode layer 331. A thickness of the conductive materials formed on the opposite surfaces of the layer of piezoelectric materials is about from 400 angstroms to 1000 angstroms.

In at least one embodiment, the first electrode layer 331 can be attached on the surface of the substrate 332 by adhesive materials, such as liquid adhesive, double side adhesive, or optical adhesive (such as optical clear adhesive or optical clear resin).

The second electrode layer 333 is similar to the first electrode layer 331. The second electrode layer 333 can include a layer of piezoelectric materials and two layers of conductive materials respectively coated on opposite surfaces of the layer of piezoelectric materials. For example, the conductive materials can be metal materials having good conductive performance Some example of the metal materials include, but not limit to, argentums, aluminum, copper, nickel, or alloy thereof. In other embodiments, the conductive materials can be transparent conductive materials, such as indium tin oxide, zinc oxide, Poly(3,4-ethylenedioxythiophene), carbon nanotube, Ag nano wire, or graphene. The piezoelectric materials can be polyvinylidene fluoride.

In at least one embodiment, the second electrode layer 333 can serve as a signal transmission layer to produce ultrasonic waves when it is powered. When an external object touches or moves to the second fingerprint sensor 330, the ultrasonic waves come to the external object and are reflected by the external object. The first electrode layer 331 can serve as a signal receiving layer to receive the ultrasonic waves reflected from the external object and to convert the ultrasonic waves into electric signals. The electric signals are transmitted to the TFTs 334 for analyzing, thereby realizing the fingerprint recognition function of the second fingerprint sensor 330.

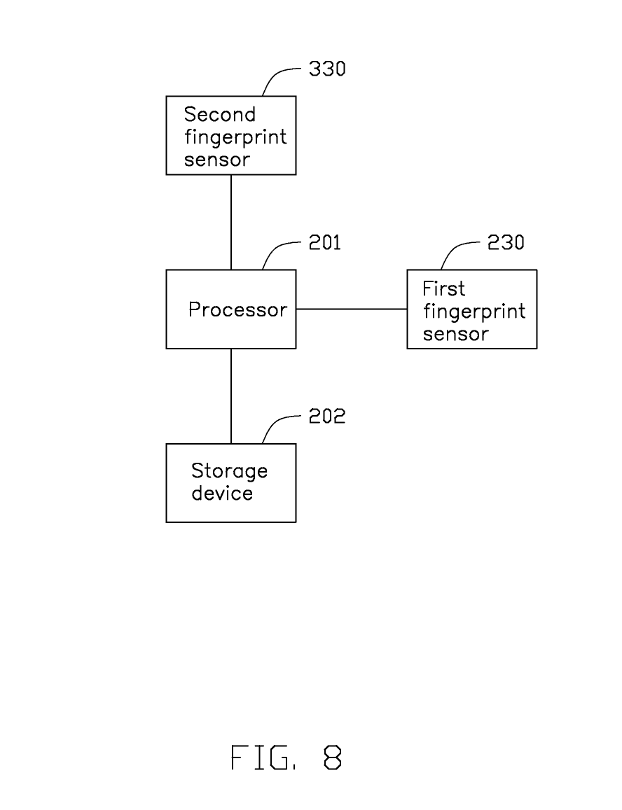

As illustrated in FIG. 8, the electronic device 200 can further includes a processor 201 and a storage device 202 coupled to the processor 201. The processor 201 is coupled to both the first fingerprint sensor 230 and the second fingerprint sensor 330. In at least one embodiment, each of the first and second fingerprint sensors 230, 330 is associated with a predetermined function of the electronic device 200. When one of the first and second fingerprint sensors 230, 330 acquires a fingerprint which matches one of at least one predetermined fingerprint stored in the storage device 202, the processor 201 controls the electronic device 200 to perform the predetermined function associated with the one of the first and second fingerprint sensors 230, 330.

In at least one embodiment, the first fingerprint sensor 330 can be associated with a first function of the electronic device 200 and the second fingerprint sensor 330 is associated with a second function of the electronic device 200. The first function may be to power off the electronic device 200 and the second function may be to unlock the electronic device 200. A first predetermined fingerprint and a second predetermined fingerprint may be pre-stored in the storage device 202. When a fingerprint is acquired by the first fingerprint sensor 330, the processor 201 compares the acquired fingerprint with the first predetermined fingerprint. If the acquired fingerprint matches the first predetermined fingerprint, the processor 201 automatically powers off the electronic device 200. In the same manner, if the second fingerprint sensor 330 acquires a fingerprint that matches the second predetermined fingerprint, the processor 201 may unlock the electronic device 200. Thus, some functions of the electronic device 200 can be quickly and automatically triggered when appropriated fingerprints are input.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims.

What is claimed is:

1. An electronic device comprising:
at least one curved region; and
at least one fingerprint sensor installed under the curved region and configured to acquire, when the at least one curved region is touched, at least one fingerprint.

2. The electronic device according to claim 1, wherein each of the at least one fingerprint sensor is an ultrasonic fingerprint sensor.

3. The electronic device according to claim 2, wherein the at least one fingerprint sensor comprises a substrate and a pair of electrode layers coupled at opposite sides of the substrate.

4. The electronic device according to claim 3, wherein the substrate is a curved substrate.

5. The electronic device according to claim 3, wherein the substrate is made of flexible materials.

6. The electronic device according to claim 1, wherein the curved region is a part of the electronic device having a curved inner side surface and a curved outside surface.

7. The electronic device according to claim 1, further comprising a curved display screen and a second fingerprint sensor located under the curved display screen for acquiring fingerprint when the curved display screen is touched.

8. The electronic device according to claim 7, wherein the second fingerprint sensor is an ultrasonic fingerprint sensor.

9. The electronic device according to claim 8, wherein the fingerprint sensor comprises a substrate and a pair of electrode layers coupled at opposite sides of the substrate, and each of the substrate and the pair of electrode layers has a curved inner side surface and a curved outside surface.

10. The electronic device according to claim 7, wherein each of the first fingerprint sensor and the second fingerprint sensor is associated with a predetermined function of the electronic device; when one of the first and second fingerprint sensors acquires a fingerprint that matches one of at least one predetermined fingerprint, the electronic device performs the predetermined function associated with the one of the first and second fingerprint sensors.

11. The electronic device according to claim 1, further comprising at least one button located within the curved region, wherein the first fingerprint sensor is located under the curved region to correspond to the at least one button.

12. An electronic device, comprising:
a plurality of buttons; and
at least two fingerprint sensors respectively located under at least two of the plurality of buttons;
wherein each of the at least two fingerprint sensors is associated with a predetermined function of the electronic device; when one of the at least two fingerprint sensors acquires a fingerprint that matches one of at least one predetermined fingerprint, the electronic device performs the predetermined function associated with the one of the at least two fingerprint sensors.

13. The electronic device according to claim 12, further comprising a processor and a storage device, wherein the storage device stores the at least one predetermined fingerprint, and the processor compares the fingerprint the fingerprint acquired by the one of the at least two fingerprint sensors with the at least one predetermined fingerprint and controls the electronic device to perform the predetermined function when the acquired fingerprint matches one of the at least one predetermined fingerprint.

14. The electronic device according to claim 12, wherein the plurality of buttons comprise a first button and a second button, the at least fingerprint sensors comprise a first fingerprint sensor and a second fingerprint sensor, the first fingerprint sensor is associated with a first function of the electronic device and the second fingerprint sensor is associated with a second function of the electronic device.

15. The electronic device according to claim 14, wherein the at least one predetermined fingerprint comprises a first predetermined fingerprint and a second predetermined fingerprint; when the first fingerprint sensor acquires a fingerprint that matches the first predetermined fingerprint, the electronic device performs the first function; when the second fingerprint sensor acquires a fingerprint that matches the second predetermined fingerprint, the electronic device performs the second function.

16. The electronic device according to claim 15, wherein the first function is to power off the electronic device.

17. The electronic device according to claim 15, wherein the second function is to unlock the electronic device.

18. The electronic device according to claim 12, wherein each of the at least two fingerprint sensor is an ultrasonic fingerprint sensor.
